(19) United States
(12) Patent Application Publication
(10) Pub. No.: US 2020/0361630 A1
(43) Pub. Date: Nov. 19, 2020

(54) POSITION SETTING MECHANISM, UNMANNED AERIAL VEHICLE BASE STATION, AND UNMANNED AERIAL VEHICLE SYSTEM

(71) Applicant: SZ DJI TECHNOLOGY CO., LTD., Shenzhen (CN)

(72) Inventors: Hao WANG, Shenzhen (CN); Peng WANG, Shenzhen (CN)

(21) Appl. No.: 16/839,764

(22) Filed: Apr. 3, 2020

Related U.S. Application Data
(63) Continuation of application No. PCT/CN2017/108722, filed on Oct. 31, 2017.

(51) Int. Cl. B64F 1/02; B64C 39/02

(52) U.S. Cl. CPC B64F 1/0297; B64C 2201/18; B64C 39/024

(57) ABSTRACT

A position setting system including a first side plate, a second side plate and a bottom plate with two sides parallel to a length direction, each of the two sides abutting a respective side plate. The position setting system also has a first positioning device and a second positioning device configured to move along at least one of the two sides of the bottom plate, towards each other to guide and position a landing gear of the UAV to be between the first positioning device and the second positioning device during landing. During take-off, the first positioning device and the second positioning device are moved away from each other.

### CROSS-REFERENCE TO RELATED APPLICATION

This application is a continuation of International Application No. PCT/CN2017/108722, filed Oct. 31, 2017, the entire content of which is incorporated herein by reference.

### TECHNICAL FIELD

The present disclosure relates to an unmanned aerial vehicle (UAV) or a drone, and more particularly, to a position setting system, a UAV base station and a UAV system.

### BACKGROUND

In recent years, with the rapid development of Unmanned Aerial Vehicle (UAV) technology, UAVs have become more and more widely used. For example, UAVs are used to transport goods in the transportation industry. UAVs are used to dust pesticides in the agricultural and plant protection fields to prevent pests, and so on. In order to ensure the supply of goods for logistics drones or UAVs, water and pesticide supply for agriculture protection drones, or power supply when drones work, drones need to be landed at a predetermined point and fixed to the exact location required.

Currently, UAV positioning solutions use a fully active positioning approach. Specifically, after the UAV descends on the ground, the UAV is moved to a desired position by an actuator such as a motor. Three dimensions may be adjusted when fixing the UAV on a plane, including two linear dimensions and an angle.

However, the fully active positioning approach requires the use of many actuators. Fixing three dimensions of the UAV makes the positioning complicated and increases the complexity of the positioning device.

### SUMMARY

One aspect of the present disclosure provides a position setting system including a base, a positioning plate, a first positioning device, a second positioning device, and a driving device. The positioning plate is disposed on the base and includes a bottom plate and two side plates. The two side plates are respectively disposed on the opposite sides of the bottom plate. The side plates are used when a UAV is landing to guide the UAV to the bottom plate. More specifically, the first positioning device and the second positioning device are respectively disposed at two ends of the bottom plate. The driving device is disposed below the bottom plate to drive one of the first positioning device and the second positioning device to move towards each other when the UAV lands, guiding a landing gear of the UAV to be positioned between the first positioning device and the second positioning device. The driving device further drives one of the first positioning device and the second positioning device away from each other when the UAV takes off.

Another aspect of the present disclosure includes a UAV base station with a position setting system. The position setting system includes a first side plate, a second side plate and a bottom plate with two sides parallel to a length direction, each of the two sides abutting a respective side plate. The position setting system includes a first positioning device and a second positioning device configured to move along the two sides of the bottom plate, towards each other to guide a UAV during landing, and away from each other during taking-off of the UAV.

### BRIEF DESCRIPTION OF THE DRAWINGS

FIG. 1 is a perspective view of the structure of a position setting system according to an example embodiment of the present disclosure.

FIG. 2 is a top plane view of the position setting system according to an example embodiment of to the present disclosure.

FIG. 3 is a front view of the position setting system of an example embodiment according of the present disclosure.

FIG. 4 is a perspective view of the structure of a second positioning device according to an example embodiment of the present disclosure.

FIG. 5 is a perspective view of a locking mechanism of a landing gear enabled by a push-pull solenoid valve on the second positioning device according to an example embodiment of the present disclosure.

FIG. 6 is a perspective view of the structure of a first positioning device according to an example embodiment of the present disclosure.

FIG. 7 is a perspective view of the structure of a driving device according to an example embodiment of the present disclosure.

FIG. 8 is an exploded structure diagram of the driving device according to an example embodiment of the present disclosure.

FIGS. 9A to 9D are perspective views showing multiple states of the position setting system during landing and take-off of a UAV according to an example embodiment of the present disclosure.

FIGS. 10A to 10C are perspective views showing multiple states of the position setting system during landing and take-off of a UAV according another example embodiment of the present disclosure.

### DETAILED DESCRIPTION OF THE EMBODIMENTS

Detailed description of the present disclosure is described with reference to the drawings. It should be appreciated that the described embodiments are exemplary embodiments, and only part of rather than the entirety of the embodiments of the present disclosure. Any embodiments conceived by those skilled in the art enlightened by the teaching of the described embodiments should be within the scope of the present disclosure.

As herein included, when a first component is referred to as “fixed to” a second component, it is intended that the first component may be directly attached to the second component or may be indirectly attached to the second component via another component. When a first component is referred to as “connecting” to a second component, it is intended that the first component may be directly connected to the second component or may be indirectly connected to the second component via a third component between them

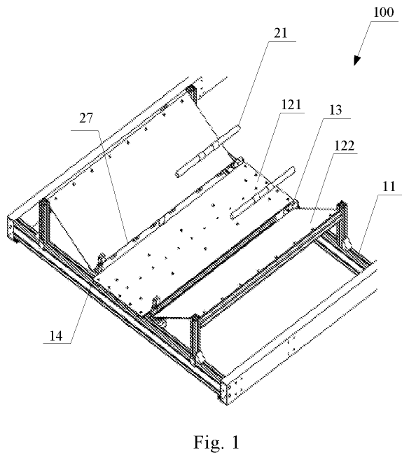

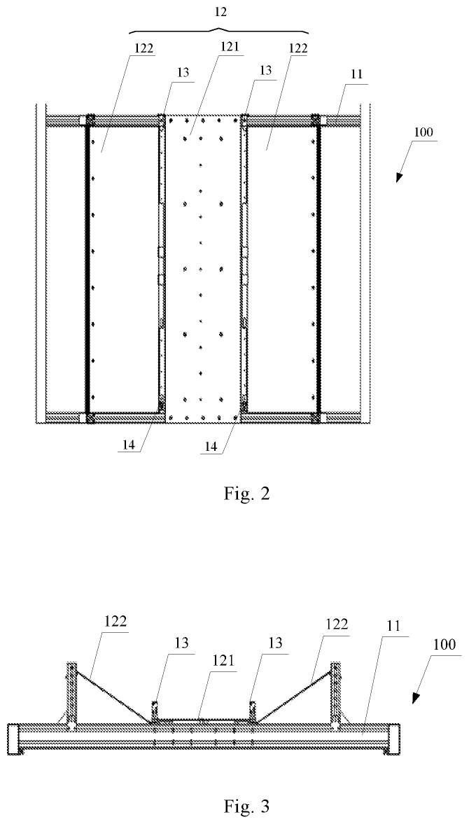

FIG. 1 is a perspective view of the structure of a position setting system according to an example embodiment according to the present disclosure. FIG. 2 is a top plane view of the position setting system according to an example embodiment according to the present disclosure. FIG. 3 is a front view of the position setting system of an example embodiment according of the present disclosure.

As shown in FIGS. 1-3, the position setting system 100 according to one embodiment may include a base 11, a positioning plate 12, a first positioning device 13, a second positioning device 14, and a driving device (not shown). The position setting system 100 according to this embodiment can be applied to a base station of a UAV to position the UAV when the UAV is landing.

The positioning plate 12 may be disposed on the base 11 and may include a bottom plate 121 and two side plates 122. The two side plates 122 are respectively disposed on opposite sides of the bottom plate 121. The side plate 122 is used to guide the UAV to the bottom plate 121 when the UAV is landing.

The first positioning device 13 and the second positioning device 14 are respectively disposed at both ends of the bottom plate 121.

The driving device may be disposed below the bottom plate 121 and may be used for driving one of the first positioning device 13 and the second positioning device 14 to move towards the other one of the two positioning devices when the UAV is landing, so as to position one or more landing gears 21 of the UAV between the first positioning device 13 and the second positioning device 14. When the UAV takes off, one of the first positioning device 13 and the second positioning device 14 is driven by the driving device to move away from the other one of the two positioning devices.

Still referring to FIGS. 1-3, in this exemplary embodiment, a positioning plate 12 is provided on the base 11. The positioning plate 12 includes a bottom plate 121 and two side plates 122. The bottom plate 121 may have a length direction and a width direction. Both sides of the bottom plate 121 in the length direction may be referred to as long sides, and both sides of the bottom plate 121 in the width direction may be referred to as short sides. The two side plates 122 are respectively disposed on two opposite sides (long sides) of the bottom plate 121 in the length direction. The bottom plate 121 and the two side plates 122 are surrounded to form a landing area for the UAV. The side plates 122 have a guiding effect in the landing process of the UAV. Because it is very difficult to land absolutely accurately at a designated position when the UAV is landing, the two side plates can guide the UAV to the ground and land in the landing area. The opposing surfaces of each of the two side plates 122 may be referred to as a guide surface, and the guide surface is not restricted to a certain shape. For example, the guide surface may be a flat surface or a concave surface. The concave surface may be a curved concave surface or a spherical concave surface. The upper surface of the bottom plate 121 may be referred to as a positioning surface, and in this embodiment, the shape of the positioning surface is not limited. For example, the positioning surface may be a flat surface or a concave surface.

The length of the bottom plate 121 may be greater than the width of the bottom plate 121. The width of the bottom plate 121 may be substantially equal to the width between two landing gears 21 of the UAV. As such, when the UAV is landing, the landing gears 21 of the UAV can be translated along the length direction of the bottom plate 121 but cannot be rotated.

The first positioning device 13 and the second positioning device 14 are respectively disposed at two ends of the length direction of the bottom plate 121, and a driving device is provided below the bottom plate 121. The driving device may drive the first positioning device 13 and the second positioning device 14 to move relatively closer to or away from each other along the length direction of the bottom plate 121. When the UAV is at landed status, the landing gear 21 can move along the length direction of the bottom plate 121. Therefore, the driving device can drive one of the first positioning device 13 and the second positioning device 14 to move towards the other. As a result, the first positioning device 13 or the second positioning device 14 may drive the landing gear 21 of the UAV along the bottom plate 121. The landing gear 21 is moved in the length direction of the bottom plate 121 until the landing gear 21 of the UAV is positioned between the first positioning device 13 and the second positioning device 14. The driving device may also drive the first positioning device 13 and the second positioning device 14 to move away from each other until the first positioning device 13 and/or the second positioning device 14 detaches from the landing gear 21. In this example embodiment, one of the first positioning device 13 and the second positioning device 14 can move towards or away from the other. For example, the first positioning device 13 may be in a fixed position while the second positioning device 14 moves towards or away from the first positioning device 13. Vice versa, the second positioning device 14 may be in a fixed position while first positioning device 13 moves toward or away from the second positioning device 14.

In the position setting system 100 provided in this embodiment, during the landing of the UAV, the initial positions of the first positioning device 13 and the second positioning device 14 are respectively located at the respective two ends of the bottom plate 121. It is difficult for the UAV to land accurately at the designated position (without reiteration). When the landing gear 21 of the UAV comes into touch with at least one side plate 122, the side plate(s) 122 can, by fulfilling the guiding function, guide the UAV to the bottom plate 121 and correct the position deviation when the UAV is landing. After the UAV has landed, the landing gear 21 of the UAV is located between the first positioning device 13 and the second positioning device 14. The landing gear 21 is not configured to rotate rather to move along the length direction of the bottom plate 121. For this situation, the driving device drives either one of the first positioning device 13 and the second positioning device 14 to move towards the other, until the first positioning device 13 or the second positioning device 14 comes into contact with the landing gear 21 of the UAV. Subsequently, the driving device drives the landing gear 21 of the UAV to move toward the second positioning device 14 or the first positioning device 13, until the landing gear 21 of the UAV is positioned between the first positioning device 13 and the second positioning device 14.

During the take-off process, it can be seen that the position setting system 100 provided in this embodiment is configured to drive one of the either one of the first positioning device 13 and the second positioning device 14 to move away from each other, until the first positioning device 13 and/or the second positioning device 14 is set apart from the landing gear 21 of the UAV to allow the unmanned UAV to take off.

Therefore, the position setting system according to some embodiments of the present disclosure is configured to correct the obvious positioning deviation by using the guiding effect of the side plate when the UAV is landing. Moreover, the driving device is configured to position the UAV in the position setting system by driving the first positioning device and the second positioning device to move towards or away from each other, the first positioning device and/or the second positioning device being positioned at the both ends of the bottom plate, which sets the position of the UAV using just one driving mechanism. This configuration simplifies the structure of the position setting system and improve the stability and reliability of the UAV positioning.

In some embodiments, a side of the side plate(s) 122 and a side of the bottom plate 121 in the length direction may abut with each other. For one embodiment, the distance between the two intersection points of the two side plates 122 intersecting with the bottom plate 121 coincides with the width of the bottom plate 121. This may be also be the distance between the two landing gears 21 of the UAV.

In some other embodiments, the side of the side plate 122 and the corresponding side of the bottom plate 121 in the longitudinal direction may be separated from each other. For one embodiment, the distance between the two side plates 122 is greater than the width of the bottom plate 121, and the distance between the two side plates 122 may be the distance between the two landing gears 21 of the UAV.

Alternatively, the side plate 122 may be attached on the base 11. For example, the side plate 122 may be a sloping plate fixedly disposed on the base 11 and forming a predetermined angle with the horizontal plane. When the angles are different, the height of the side plate 122 relative to the bottom plate 121 may be different. The angle may be, for example, 45°, 30°, or the like. At this time, the landing area of the UAV formed by the two side plates 122 and the bottom plate 121 is a fixed landing area.

Alternatively, the side plate 122 may be movably disposed on the base 11. The movement of the side plate 122 relative to the base 11 may be used to adjust the height of the side plate 122 relative to the bottom plate 121 and/or the distance between the side plate 122 and the bottom plate 121. For this embodiment, the landing area of the UAV formed by the two side plates 122 and the bottom plate 121 is a variable area that can be adjusted in size. It should be noted that, in this embodiment, the manner in which the side plate 122 is movably connected to the base 11 is not limited to one kind. In some embodiments, the side plate 122 may be rotatably connected to the base 11, and the rotation axis may be a side of the side plate 122. When the side plate 122 is rotated to different positions, the height of the side plate 122 relative to the bottom plate 121 may be different. In some embodiments, the side plate 122 can be folded on the base. When the position setting system 100 is used for landing of the UAV, the side plate 122 is in an extended state. When the position setting system 100 is not used for landing of the UAV, the side plate 122 is in a folded state. In some other embodiments, the side plates 122 may be moved along the width direction of the bottom plate 121 to adjust the distance between the side plates 122.

By movably disposing the side plate on the base, it is beneficial to reduce the size of the space occupied by the positioning device and have the flexibility to adjust the landing space of the UAV. All such variations are within the scope of application of the positioning device.

It should be noted that the structure of the base 11 is not particularly limited in the present disclosure and may be configured according to actual needs. For example, when the position setting system 100 is applied in a UAV base station, the base 11 may be a frame of the UAV base station.

In some embodiments, one or more grooves 27 may be provided between the side plate(s) 122 and the bottom plate 121. The first positioning device 13 may be attached at one end of the groove, and the second positioning device 14 may be disposed in the groove, being attached to the driving device.

The driving device is configured to drive the second positioning device 14 to move relatively towards or away from the first positioning device 13 in the groove.

Specifically, when the UAV is landing, the landing gear(s) 21 may be disposed in the groove(s) between the side plate(s) 122 and the bottom plate 121. The first positioning device 13 may be fixed at one end of the groove, and the second positioning device 14 may be disposed in the groove. The first positioning device 13 can be moved towards or away from the first positioning device 13 in the groove driven by the driving device. Therefore, the second positioning device 14 may push the landing gear 21 in the groove to the first positioning device 13 until the landing gear 21 of the UAV is positioned between the first positioning device 13 and the second positioning device 14.

By providing the groove, within which the landing gear of the UAV to be moved, it further limits the movement of the UAV on the position setting system, facilitating the rapid positioning of the UAV, and simplifying the complexity of the position setting system.

In some embodiments, the first positioning device 13 is fixedly disposed on one end of the bottom plate 121. A sliding groove parallel to the length direction of the bottom plate 121 is provided on the other end of the bottom plate 121. A positioning frame is provided on the base 11, crossing and being perpendicular to the sliding groove. The second positioning device 14 is disposed on the positioning frame. The bottom plate 121 is attached to the driving device.

The driving device is configured to drive the positioning plate 12 to move along the length direction of the bottom plate 121.

Specifically, a side of the side plate 122 and a side of the bottom plate 121 in the length direction may be abutting with each other. When the UAV is landing, the landing gear 21 may be located at the intersection of the side plate 122 and the bottom plate 121. The first positioning device 13 may be fixed on one end of the bottom plate 121, and the second positioning device 14 may be fixed on the base 11. The driving device can drive the positioning plate 12 to move along the length direction of the bottom plate 121, so that the positioning plate 12 can drive the first positioning device 13 to move towards or away from the second positioning device 14. When the UAV lands, the positioning plate 12 simultaneously drives the UAV and the first positioning device 13 to move toward the second positioning device 14. The landing gear 21 of the UAV first comes into contact with the second positioning device 14 and positions the landing gear 21 to the second positioning device 14. The positioning plate 12 continues to move along until the landing gear 21 comes into contact with the first positioning device 13. Then the landing gear 21 is positioned between the first positioning device 13 and the second positioning device 14. When the UAV takes off, the positioning plate 12 simultaneously drives the UAV and the first positioning device 13 away from the second positioning device 14. The landing gear 21 of the UAV sets apart from the second positioning device 14, then the UAV can take off.

The positioning plate driving the first positioning device to move relatively towards or away from the second positioning device contributes to the rapid positioning of the UAV and improves the stability of the UAV operation.

It can be appreciated the number of the first positioning device 13 and the second positioning device 14 is not limited to what is shown in the example embodiments.

In some embodiments, as an example, there is one for each of the first positioning device 13 and the second positioning device 14. The first positioning device 13 is disposed on one end of the bottom plate 121, and the second positioning device 14 is correspondingly disposed on the other side of the bottom plate 121. The first positioning device 13 and the second positioning device 14 are disposed on the same side of the bottom plate 121 in the length direction. The first positioning device 13 and the second positioning device 14 are configured to position one landing gear 21 of two landing gears 21 of the UAV.

In some embodiments, as another example, there are two for each of the first positioning device 13 and the second positioning device 14. The two first positioning devices 13 are disposed at one end of the bottom plate 121, and the two second positioning devices 14 are disposed correspondingly on the other end of the bottom plate 121. The first positioning device 13 and the second positioning device 14 on one side of the bottom plate 121 are configured to position one landing gear of the two landing gears 21 of the UAV, and the first positioning device 13 and the second positioning device 14 on the other side of the bottom plate 121 are configured to position the other landing gear of the two landing gears 21 of the UAV.

According to the present disclosure, the configurations and structures of the first positioning device 13 and the second positioning device 14 are not limited to what are shown in the example embodiments. In some embodiments, the configurations and structures of the first positioning device 13 and the second positioning device 14 may be the same.

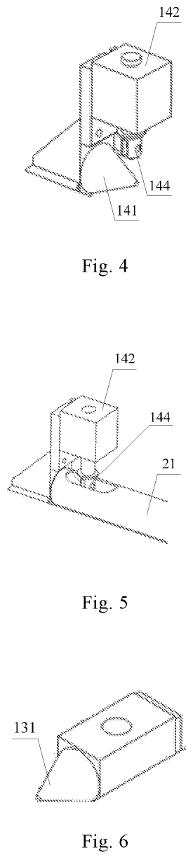

FIG. 4 is a perspective view of the structure of a second positioning device according to an example embodiment of the present disclosure. The second positioning device 14 may include a positioning member 141 for positioning the landing gear 21 of the UAV in the length direction of the bottom plate 121 when the UAV is landing. In some embodiments, for an example, the positioning member 141 may have a positioning concave surface, and the shape of the positioning concave surface matches or compliments the shape of the end surface of the landing gear of the UAV. One end of the landing gear of the UAV can be inserted into the positioning concave surface. In some other embodiments, for another example, the positioning member 141 may be of protruding structure for positioning. In yet some other embodiments, the landing gear of the UAV may include a positioning groove matching the protrusion structure of the positioning member 141. For example, the protrusion structure may be a positioning column whose central axis is parallel to the length direction of the bottom plate. As another example, as shown in FIG. 4, the positioning member 141 may be a positioning cone, the central axis of which may be parallel to a length direction of the bottom plate 121.

The embodiments according to the present disclosure provide a closer contact between the second positioning device and the landing gear of the UAV by providing a positioning member on the second positioning device. This results in improved stability of the position setting system for landing the UAVs.

FIG. 5 is a perspective view of a locking mechanism of the landing gear enabled by a push-pull solenoid valve on the second positioning device according to an example embodiment of the present disclosure. Some embodiments are shown in FIGS. 4 and 5. The second positioning device may include the push-pull solenoid valve 142, which is used to lock the landing gear 21 of the UAV when the UAV is landing, and to unlock the landing gear 21 after the UAV moves away from the bottom plate for a predetermined distance when the UAV is taking off. In many embodiments, the push-pull solenoid valve 142 may include a retraction or telescopic column 144. In some embodiments, the landing gear 21 of the UAV may be provided with a positioning groove matching the push-pull solenoid valve 142. The landing gear 21 of the UAV is locked through the positioning groove of the telescopic column 144 protruding into the landing gear 21 of the UAV.

Specifically, during the landing of the UAV, the landing gear 21 of the UAV is positioned, while the UAV is guided to the bottom plate 121 by the guiding effect of the side plate(s) 122, between the first positioning device 13 and the second positioning device 14. The driving device drives one of the first positioning device 13 and the second positioning device 14 to move towards or away from the other until the landing gear 21 of the UAV is positioned between the first positioning device 13 and the second positioning device 14. The push-pull solenoid valve 142 is powered on, the telescopic column 144 extends toward the landing gear 21 of the UAV until the landing gear 21 is locked. Then the push-pull solenoid valve 142 is powered off. The landing gear of the UAV is locked by a push-pull solenoid valve, which enhances the stability of the UAV on the position setting system.

During the take-off process of the UAV, the driving device drives one of the first positioning device 13 and the second positioning device 14 to move away from each other. At the moment of this situation, the landing gear 21 is still locked by the push-pull solenoid valve 142 on the second positioning device 14. Since the push-pull solenoid valve 142 is at a locked status, as the distance between the first positioning device 13 and the second positioning device 14 is widened, the UAV is driven to move a predetermined distance relative to the bottom plate 121 until the push-pull solenoid valve 142 is energized. Subsequently the telescopic column 144 is contracted away from the landing gear 21 of the UAV to unlock the landing gear 21. Then the push-pull solenoid valve 142 is de-energized. As the distance between the first positioning device 13 and the second positioning device 14 continues to increase, the landing gear 21 of the UAV located between the first positioning device 13 and the second positioning device 14 is out of contact with the first positioning device 13 and the second positioning device 14. The UAV is then able to take off.

By setting a push-pull solenoid valve on the second positioning device, the landing gear of the UAV can be further locked when the UAV is landing, thereby further improving the stability of the UAV on the position setting system when the UAV is landing. Moreover, the UAV can be dragged to a desired position on the bottom plate during the take-off of the UAV, making the take-off of the UAV easier.

It should be noted that, in the present disclosure, the direction of telescopic column of the push-pull solenoid valve is not limited to what's shown in this embodiment. For example, a push-pull solenoid valve can lock the landing gear of the UAV in a vertical direction, and it can alternatively or also lock the landing gear of the UAV in the horizontal direction. All such variations are within the scope of the present disclosure.

It should be noted that the specific value of the predetermined distance is not limited in this embodiment and can be set as required. For example, the predetermined distance may be ½ of the length of the bottom plate.

In some embodiments, a plurality of sensors may be disposed below the bottom plate 121 to detect a relative moving distance between the first positioning device 13 and the second positioning device 14. In this embodiment, the specific predetermined positions and types of the sensor are not limited, and the configuration is performed according to actual needs. For example, the sensor may be a position sensor. All such variations are within the scope of the present disclosure.

FIG. 6 is a perspective view of the structural of a first positioning device according to an example embodiment of the present disclosure. In some embodiments, as shown in FIG. 6, the first positioning device may include a positioning member 131 for positioning the landing gear of the UAV in the length direction of the bottom plate when the UAV is landing. For the mechanism and the technical implementation of the positioning member 131, reference may be made to the description of the positioning member 141, and details are not herein repeated. As shown in FIG. 6, as an example of the first positioning device, the positioning member 131 may be a positioning cone.

Alternatively, the first positioning device may include a locking member for locking the landing gear of the UAV when the UAV is landing. The implementation manner of the locking member is not limited in this embodiment. For example, the lock key may be an electric snap, or an electronic switch for controlling the driving device.

Alternatively, for example, the first positioning device may include a push-pull solenoid valve, which is used to lock the landing gear of the UAV when the UAV is landing, and to unlock the landing gear of the UAV when the UAV is taking off. Further alternatively, the landing gear of the UAV may be provided with a positioning groove matching the push-pull solenoid valve. The principle of the push-pull solenoid valve can be referred to the description of the second positioning device and is not repeated here.

Alternatively, in this embodiment, the driving device includes a driving member for driving the first positioning device 13 and/or the second positioning device 14 to move, and a guiding member, for guiding the first positioning device 13 and/or the second positioning device 14 to move in a predetermined direction.

Alternatively, the driving member may include at least one of the following: a rotary motor, a linear motor, a telescopic column, or a rotary column.

Alternatively, the guiding member may include at least one of the following: a slider and a slide rail, or a guide sleeve and a guide rod.

It should be noted that, the attachment method of the driving member and the guiding member is not limited by this example embodiment, and a known attachment method may be adopted.

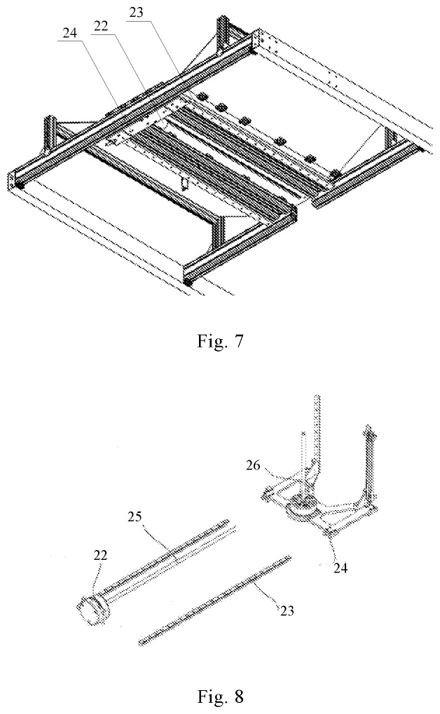

As an example, FIG. 7 is a perspective view of the structure of a driving device according to an example embodiment of the present disclosure. FIG. 8 is a perspective view of the structure the driving device according to an example embodiment of the present disclosure. As shown in FIG. 7 and FIG. 8, the driving member may be an electrical rotary motor 22, and the guiding member includes a slide rail 23 and a slider 24. The driving device further includes a screw rod 25 and a screw nut 26 sleeved on the screw rod. The drive shaft of the rotary motor 22 is fixedly connected to one end of the screw rod 25 coaxially. The screw nut 26 is attached to the slider 24. On the slide rail 23, the slide rail 23 is disposed along the length direction of the bottom plate 121.

The rotary motor 22 is configured to drive the screw rod 25 to rotate. The screw rod 25 and the nut 26 may be attached together, for example by screws, to drive the nut 26 to move. The nut 26 may drive the slider 24 to move on the slide rail 23.

This embodiment provides a position setting system including a base, a positioning plate, a first positioning device, a second positioning device, and a driving device. The positioning plate is disposed on the base and includes a bottom plate and two side plates, and the two side plates are respectively disposed on opposite sides of the bottom plate. The side plate is used to guide the UAV to the bottom plate when the UAV is landing. The first positioning device and the second positioning device are respectively disposed at two ends of the bottom plate. The driving device is arranged below the bottom plate, and is configured to drive one of the first positioning device and the second positioning device to move towards the other when the UAV is landing, so as to position the landing gear of the UAV between the first positioning device and the second positioning device. When the UAV takes off, the driving device is configured to drive one of the first positioning device and the second positioning device to move away from each other. The position setting system provided in this embodiment can guide the UAV to the bottom plate by the guiding effect of the side plate and correct significant positioning errors when the UAV is landing. By positioning the first positioning device and the second positioning device at both ends of the bottom plate, and driving the first positioning device and/or the second positioning device to move relatively towards or away from each other, it is possible to use one power source to complete the positioning of the UAV on the position setting system. This also contributes to simplify the structure of the position setting system and improve the stability and reliability of the UAV positioning.

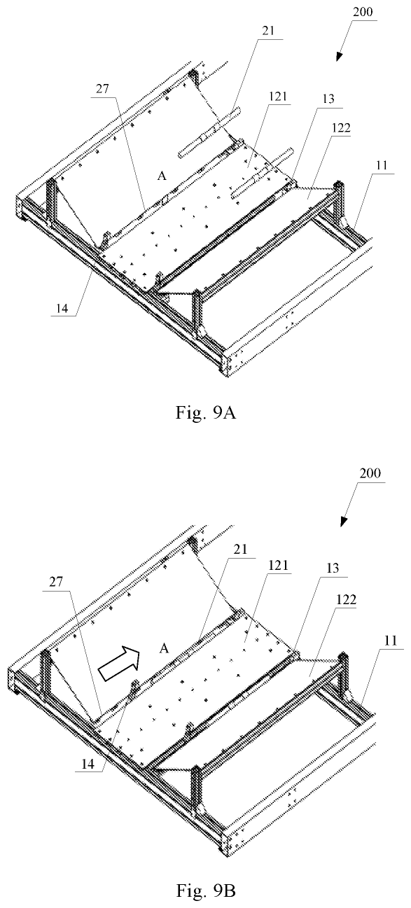

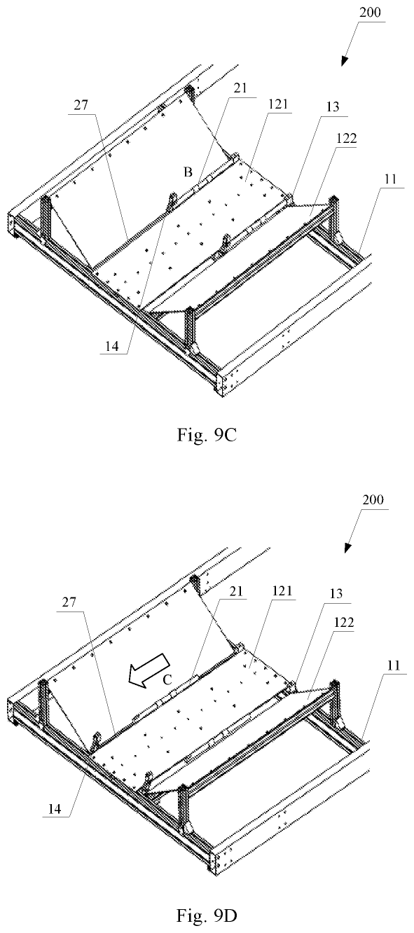

Based on some embodiments as described above, FIGS. 9A-9D are perspective views showing multiple states of the position setting system during landing and take-off of the UAV according to an example embodiment of the present disclosure.

This embodiment provides a specific structure of the position setting system based on the embodiments shown in FIG. 1 to FIG. 8 as described above. As shown in FIGS. 9A to 9D, the position setting system 200 herein provided in this embodiment may include: the base 11, the positioning plate 12, the first positioning device 13, the second positioning device 14, and the driving device.

The positioning plate 12 is disposed on the base 11 and includes a bottom plate 121 and two side plates 122. The two side plates 122 are respectively disposed on opposite sides of the bottom plate 121. The side plate 122 is used to guide the UAV to the bottom plate 121 when the UAV lands.

The first positioning device 13 and the second positioning device 14 are respectively disposed at both ends of the bottom plate 121.

Wherein, the driving device is disposed below the bottom plate 121 and is configured to drive one of the first positioning device 13 and the second positioning device 14 to move towards the other when the UAV lands, in order to dispose the landing gear 21 of the UAV between the first positioning device 13 and the second positioning device 14. When the UAV takes off, one of the first positioning device 13 and the second positioning device 14 is driven to move away from each other.

A groove 27 is provided between the side plate 122 and the bottom plate 121. The first positioning device 13 is fixedly disposed at one end of the groove 27. The second positioning device 14 is disposed in the groove 27 and connected to the driving device.

The driving device is used to drive the second positioning device 14 to move relatively towards or away from the first positioning device 13 in the groove 27.

There are two for each of the first positioning device 13 and the second positioning device 14. The two first positioning devices 13 are disposed on one end of the bottom plate 121, and the two second positioning devices 14 are correspondingly disposed on the other end of the bottom plate 121. The first positioning device 13 and the second positioning device 14 on one side of the bottom plate 121 are used to position one landing gear 21 of the UAV. The first positioning device 13 and the second positioning device 14 on the other side of the bottom plate 121 are used to position the other landing gear 21 of the UAV.

The second positioning device 14 may include a positioning member and a push-pull solenoid valve. The landing gear 21 of the UAV may be provided with a positioning groove matching the push-pull solenoid valve.

The second positioning device 14 may include a positioning member.

The positioning process of the position setting system 200 provided in this embodiment during the landing of the UAV is as follows.

As shown in FIG. 9A, the position setting system 200 is assumed to be in a waiting state for the UAV to land. The first positioning device 13 and the second positioning device 14 are respectively located at two ends of the groove 27. It is known that it is very difficult for the UAV to land accurately at the designated position without reiteration. When one landing gear 21 of the UAV touches one side plate 122 (e.g., and the other landing gear of the UAV is in the air, not touching the side plate 122 on the other side of the bottom plate 121, the following occurrences of “landing gear 21” may refer to the landing gear that touches the side plate first), the UAV can be guided to the bottom plate 121 by the guiding effect of the side plate 122, and the landing gear 21 naturally settles into the groove 27 between the side plate 122 and the bottom plate 121. The position of the landing gear 21 may now be marked as position A.

As shown in FIG. 9B, the position setting system 200 is in a state that the second positioning device is moving. The driving device drives the second positioning device 14 to move toward the first positioning device 13 in the groove 27. As the second positioning device 14 gradually moves toward the first positioning device 13, the second positioning device 14 comes into contact with one end of the landing gear 21 and pushes the landing gear 21 to continue moving toward the first positioning device 13 together. As a result, the other end of the landing gear 21 is in contact with the first positioning device 13, and the landing gear 21 is positioned between the first positioning device 13 and the second positioning device 14. At this time, the position of the landing gear 21 may be marked as a position B, as shown in FIG. 9C. The push-pull solenoid valve on the second positioning device 14 is powered up, and the telescopic column extends toward the landing gear 21 of the UAV, causing the landing gear 21 to be locked. Then the push-pull solenoid valve is powered off. As such, the landing process of the UAV is completed, and the UAV is positioned on the position setting system 200.

The positioning process of the position setting system 200 provided in this embodiment during the taking-off of the UAV is as follows.

As shown in FIGS. 9C and 9D, the landing gear 21 is located at a position B. When the UAV needs to take off, the driving device drives the second positioning device 14 to move away from the first positioning device 13 in the groove 27. Since the push-pull solenoid valve on the second positioning device 14 locks the landing gear 21 of the UAV, the landing gear 21 may be driven together when the second positioning device 14 moves away from the first positioning device 13 in the groove 27. Moving away from the first positioning device 13, the landing gear 21 comes apart from the first positioning device 13. As the second positioning device 14 gradually moves away from the first positioning device 13, when the UAV reaches the position C, the push-pull solenoid valve is powered up. As a result, the telescopic column contracts in a direction away from the landing gear 21 of the UAV, and the landing gear 21 is unlocked. After that, the second positioning device 14 continues to move away from the first positioning device 13 until it reaches an end of the groove 27. The UAV can take off at position C, completing the UAV take-off process.

It can be seen that, in the position setting system provided in this embodiment, the driving device drives the second positioning device to move relatively towards or away from the first positioning device. This allows for the use of one power source to complete the positioning of the UAV on the position setting system, simplifying the structure of the position setting system and improving the stability and reliability of UAV positioning.

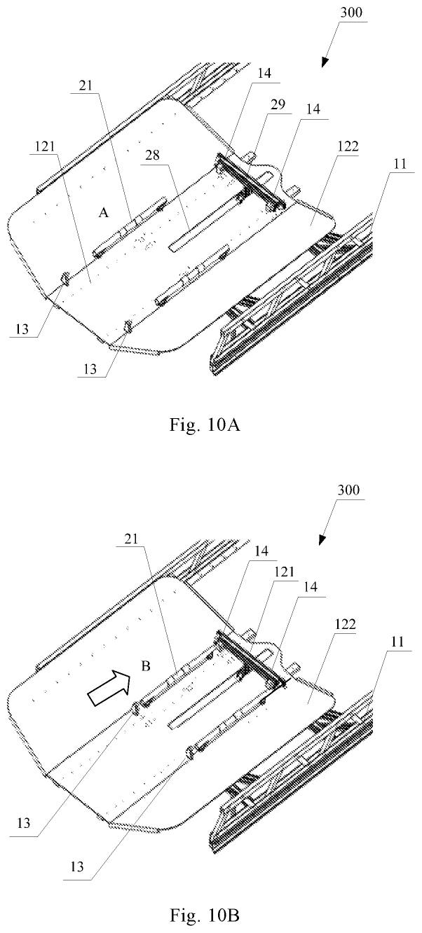

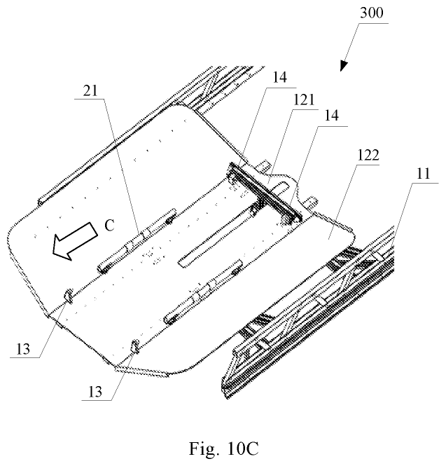

FIGS. 10A to 10C are perspective views showing multiple states of the position setting system during landing and take-off of a UAV according one example embodiment of the present disclosure. This embodiment provides another example structure of the position setting system on the basis of the embodiments shown in FIG. 1 to FIG. 8 as described above. As shown in FIG. 10A to FIG. 10C, the position setting system 300 provided in this embodiment may include: The base 11, the positioning plate 12, the first positioning device 13, the second positioning device 14, and the driving device.

The positioning plate 12 is disposed on the base 11 and includes a bottom plate 121 and two side plates 122. The two side plates 122 are respectively disposed on opposite sides of the bottom plate 121. The side plate 122 is used to guide the UAV to the bottom plate 121 when the UAV lands.

The first positioning device 13 and the second positioning device 14 are respectively disposed at both ends of the bottom plate 121

The driving device is disposed below the bottom plate 121 and is used for driving one of the first positioning device 13 and the second positioning device 14 to move towards the other when the UAV lands, in order to position the landing gear 21 of the UAV between the first positioning device 13 and the second positioning device 14. When the UAV takes off, one of the first positioning device 13 and the second positioning device 14 is driven to move away from each other.

The first positioning device 13 is fixedly disposed on one end of the bottom plate 121, and the other end of the bottom plate 121 is provided with a sliding groove 28 parallel to the length direction of the bottom plate 121. A positioning frame 29 is provided on the base 11 and extends above the base 11, crossing and being perpendicular to the sliding groove 28. The second positioning device 14 is positioned on the positioning frame 29 (e.g., the second positioning device 14 is above and not touching the bottom plate 121). The bottom plate 121 is connected to the driving device.

The driving device is used for driving the positioning plate to move along the length direction of the bottom plate 121.

There are two of each of the first positioning device 13 and the second positioning device 14. The two first positioning devices 13 are disposed on one end of the bottom plate 121, and the two second positioning devices 14 are correspondingly disposed on the other end of the bottom plate 121. One of the first positioning device 13 and one of the second positioning device 14 on the side of the bottom plate 121 are used to position the landing gear 21 of the UAV. The other one of the first positioning device 13 and the other one of the second positioning device 14 are on the other side of the bottom plate 121 and used to position other landing gear 21 of the UAV.

In one embodiment, the second positioning device 14 may include a positioning member and a push-pull solenoid valve. The landing gear 21 of the UAV may be provided with a positioning groove matching the push-pull solenoid valve.

In another embodiment, the second positioning device 14 may include a positioning member.

The positioning process of the position setting system 200 provided in this embodiment during the taking-off of the UAV is as follows.

As shown in FIG. 10A, the position setting system 300 is assumed in a waiting state for the UAV to land. The side of the side plate 122 and the side of the bottom plate 121 in the length direction may be adjacent to each other. The first positioning device 13 and the second positioning device 14 are respectively located at two ends of the bottom plate 121. It is known that it is very difficult for the UAV to land accurately at the designated position without reiteration. When the landing gear 21 of the UAV comes into contact the side plate 122, the UAV can be guided to the bottom plate 121 by the guiding effect of the side plate 122, and the landing gear 21 can be located at the intersection of the side plate 122 and the bottom plate 121. The position of the landing gear 21 may be marked as position A.

As shown in FIG. 10B, the position setting system 300 is in a state that the positioning plate is moving. The driving device drives the positioning plate to move to the second positioning device 14, so that the positioning plate can drive the first positioning device 13 and the UAV together to move to the second positioning device 14. As the positioning plate is gradually moved toward the second positioning device 14, the second positioning device 14 comes into contact with one end of the landing gear 21 and position the landing gear 21. Finally, the other end of the landing gear 21 is in contact with the first positioning device 13, and the landing gear 21 is positioned between the first positioning device 13 and the second positioning device 14. At this time, the position of the landing gear 21 may be marked as a position B. The push-pull solenoid valve on the second positioning device 14 is powered up, allowing the telescopic column to extend toward the landing gear 21 of the UAV so that landing gear 21 is locked. Then the push-pull solenoid valve is powered off. At this point, the landing process of the UAV is completed, and the UAV is positioned on the position setting system 300.

In the position setting system 300 provided in this embodiment, the process of the UAV taking off is as follows.

As shown in FIG. 10C, the landing gear 21 is located at a position B. When the UAV needs to take off, the driving device drives the positioning plate to move away from the second positioning device 14. Since the push-pull solenoid valve on the second positioning device 14 locks the landing gear 21 of the UAV, the positioning plate can drive the first positioning device 13 away from the second positioning device 14, but the UAV cannot move relatively to the second positioning device 14. The landing gear 21 comes apart from the first positioning device 13. As the positioning plate gradually moves away from the second positioning device 14, when the UAV reaches the position C on the bottom plate 121, the push-pull solenoid valve is powered on. This allows for the telescopic column to contract in a direction away from the landing gear 21 to unlock the landing gear 21. After that, the positioning plate continues to move away from the second positioning device 14, which drives the first positioning device 13 and the UAV away from the second positioning device 14 until the landing gear 21 comes apart from the second positioning device 14. The UAV can then take off at position C, completing the UAV take-off process.

It can be seen that, in the position setting system provided in this embodiment, the driving device drives the positioning plate to move towards or away from the second positioning device, and then drives the first positioning device to move toward or away from to the second positioning device. This allows for the use of one power source to complete the positioning of the UAV on the position setting system, simplifying the structure of the position setting system and improving the stability and reliability of UAV positioning.

The embodiments according to the present disclosure may also include a UAV base station, which may include the disclosed position setting system, such as those described with reference to FIG. 1 to FIG. 10C.

It should be noted that other components included in the UAV base station are not limited in the embodiments as described and may be different according to different roles of the UAV base station.

In some embodiments, the UAV base station may include an operating device for operating the UAV. The UAV is positioned onto the UAV base station by the position setting system, and the operating device can operate the positioned UAV.

In some embodiments, the operating device may include an auxiliary mechanical structure for assisting in positioning the UAV. For example, the auxiliary mechanical structure may be a one-axis auxiliary mechanical structure, a two-axis auxiliary mechanical structure, a three-axis auxiliary mechanical structure, and the like.

In some embodiments, the operating device may further include a raw material supply mechanism for replenishing the functional raw materials of the UAV.

In some embodiments, the raw material supply mechanism may further include a liquid raw material delivery interface. For example, when a UAV uses a fuel-powered device, the raw material supply mechanism may include a fuel delivery interface.

In some embodiments, the raw material supply mechanism may include a solid raw material conveying device. For example, when the UAV carries a powder spraying device for spraying powdered pesticides, the raw material supply mechanism may include a pesticide conveying track or a pesticide box holding device.

In some embodiments, the operating device may include a replacement mechanism for replacing the load of the UAV, for example, the operating device includes an auxiliary mechanical structure for replacing the gimbal mounted by the UAV.

The position setting system of the UAV base station provided in this embodiment may be the position setting system provided in any of the embodiments shown in FIG. 1 to FIG. 10C. The technical principles and technical effects are similar and not be repeated here.

The embodiments according to the present disclosure also provides an unmanned aerial vehicle (UAV or the drone) system. The unmanned aerial vehicle system may include an unmanned aerial vehicle and the UAV base station including the positioning setting system provided by any one of the foregoing embodiments shown in FIG. 1 to FIG. 10C.

The exemplary embodiments of present disclosure are not limited to any specific structure or model of the UAVs.

In some embodiments, the landing gears of the UAV may have positioning grooves compatible with the positioning member.

In some embodiments, the landing gears of the UAV may have positioning grooves compatible with the push-pull solenoid valve.

The base station of the UAV system includes the position setting system are shown in any of the embodiments as shown in FIG. 1 to FIG. 10C. The technical principles and technical effects are similar and not repeated here.

Those of ordinary skill in the art will appreciate that the example elements and algorithm steps described above can be implemented in electronic hardware, or in a combination of computer software and electronic hardware. Whether these functions are implemented in hardware or software depends on the specific application and design constraints of the technical solution. One ordinary skilled in the art can use different methods to implement the described functions for different application scenarios, but such implementations should not be considered as beyond the scope of the present disclosure.

For simplification purposes, detailed descriptions of the operations of example systems, devices, and units may be omitted, and references can be made to the descriptions of the example methods.

The disclosed systems, apparatuses, and methods may be implemented in other manners not described here. For example, the devices described above are merely illustrative. For example, the division of units may only be a logical function division, and there may be other ways of dividing the units. For example, multiple units or components may be combined or may be integrated into another system, or some features may be ignored, or not executed. Further, the coupling or direct coupling or communication connection shown or discussed may include a direct connection or an indirect connection or communication connection through one or more interfaces, devices, or units, which may be electrical, mechanical, or in other form.

The units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure.

In addition, the functional units in the various embodiments of the present disclosure may be integrated in one processing unit, or each unit may be an individual physically unit, or two or more units may be integrated in one unit.

A method consistent with the disclosure can be implemented in the form of computer program stored in a non-transitory computer-readable storage medium, which can be sold or used as a standalone product. The computer program can include instructions that enable a computer device, such as a personal computer, a server, or a network device, to perform part or all of a method consistent with the disclosure, such as one of the example methods described above. The storage medium can be any medium that can store program codes, for example, a USB disk, a mobile hard disk, a read-only memory (ROM), a random access memory (RAM), a magnetic disk, or an optical disk.

Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the disclosure being indicated by the following claims.

What is claimed is:

1. A positioning system, comprising:
a first side plate;
a second side plate;
a bottom plate with two sides parallel to a length direction, each of the two sides abutting a respective side plate;
a first positioning device; and
a second positioning device configured to move, along at least one of the two sides of the bottom plate, towards the first positioning device to guide an Unmanned Aerial Vehicle (UAV) during landing, and away from the first poisoning device during taking-off of the UAV.

2. The system of claim 1, wherein:
a groove is formed between the bottom plate and the respective side plate;
the first positioning device is fixedly disposed at one end of the groove;
the second positioning device are disposed in the groove and connected with a driving device; and
the driving device is configured to drive the second positioning device to move relatively closer to or further from the first positioning device in the groove.

3. The system of claim 1, further comprising:
a sliding groove laid in a direction parallel to the at least one of the two sides of the bottom plate and a positioning frame laid crossing the sliding groove,
wherein the first positioning device is fixedly disposed at one end of the length direction of the bottom plate, the second positioning device is fixedly disposed on the positioning frame, and the bottom plate is connected to a driving device which is configured to drive the positioning plate to move along the sliding groove.

4. The system of claim 1, wherein the first positioning device and/or the second positioning device comprises a positioning member configured to position a landing gear of the UAV in the length direction of the bottom plate during landing to be between the first positioning device and the second positioning device.

5. The system of claim 4, wherein the positioning member is a positioning cone, and a central axis of the positioning cone is parallel to the length direction of the bottom plate.

6. The system of claim 1, wherein the second positioning device comprises a push-pull solenoid valve configured to lock a landing gear when the UAV is landed and unlock the landing gear of the UAV when the UAV is moved a predetermined distance on the bottom plate when the UAV takes off.

7. The system of claim 1, wherein the first positioning device comprises a locking member for locking a landing gear of the UAV during landing.

8. The system of claim 7, wherein the locking member is a push-pull solenoid valve.

9. The system of claim 6, wherein the push-pull solenoid valve comprises a telescopic column, which, when extended, locks into a positioning groove of the landing gear of the UAV.

10. The position setting system of claim 1, wherein:
each of the first positioning device and the second positioning device are two in count,
the two first positioning devices are provided at one end of the bottom plate, and the two second positioning devices are correspondingly disposed at the other end of the bottom plate;
one pair of the first positioning device and the second positioning device located on one side of the bottom plate is configured to position a landing gear of the UAV, and the other pair of the first positioning device and the second positioning device located on the other side of the bottom plate is configured to position another landing gear of the UAV.

11. The position setting system of claim 1 further comprising a driving device that includes:
a driving member configured to drive the first positioning device and/or the second positioning device to move; and
a guiding member guiding the first positioning device and/or the second positioning device to move along a predetermined direction.

12. The position setting system of claim 11, wherein the driving member comprises at least one of: a rotary motor, a linear motor, a telescopic column, or a rotary column.

13. The position setting system of claim 12, wherein the guiding member comprises at least one of: a slider and a slide rail, or a guide sleeve and a guide rod.

14. The position setting system of claim 13, wherein:
the driving member includes a rotary motor and the guiding member includes a slide rail and a slider, the driving device further comprises a screw rod and a mating screw nut, the screw rod and a driving shaft of the rotary motor are coaxially connected, the screw nut is coupled with the slider, and the slider is configured to be deposited on the slide rail which is along the length direction of the bottom plate, and
wherein the rotary motor is used to drive the screw rod to rotate, the screw rod is mating the screw nut to drive the screw nut to move, and the screw nut drives the slider to move on the slide rail.

15. The position setting system of claim 1, wherein one of the side plates is movably disposed on a base, and a movement of the side plate relative to the base is used to adjust a height of the side plate relative to the bottom plate.

16. The position setting system according claim 1, wherein the one of the side plates includes a guide surface, and the guide surface is a flat surface.

17. A UAV base station comprising,
a position setting system, comprising:
a first side plate, a second side plate and a bottom plate with two sides parallel to a length direction, each of the two sides abutting a respective side plate;
a first positioning device and a second positioning device configured to move along at least one of the two sides of the bottom plate, towards each other to guide a UAV during landing, and away from each other during taking-off of the UAV.
